(19) United States
(12) Patent Application Publication
(10) Pub. No.: US 2004/0230983 A1
(43) Pub. Date: Nov. 18, 2004

(54) Object oriented technology system for building business websites

(76) Inventors: Shepherd S.B. Shi, Austin, TX (US); Debora B. Rinkevich, Austin, TX (US); William M. Droste, Round Rock, TX (US)

Correspondence Address: WEI TE CHUNG, FOXCONN INTERNATIONAL, INC., 1650 MEMOREX DRIVE, SANTA CLARA, CA, 95050, US

(21) Appl. No.: 10/437,615

(22) Filed: May 13, 2003

(51) Int. Cl. G06F 15/163

(52) U.S. Cl. 719/310

(57) ABSTRACT

An object oriented technology system for building business websites, the system including a web server (100), a database server (500), and a database (510). The web server runs a website development framework (200), for building business websites on the web server. The website development framework includes a plurality of predefined classes for creating business logics suitable for business websites to be built. The predefined classes can be divided into a plurality of domains. The website development framework uses of an extensible OOP technique which divides the attributes of each predefined class into basis attributes that are defined in the corresponding class, and alterable attributes that are defined in a configuration file. The database server and the database cooperatively provide storage and access services for data required by the website development framework and business websites to be built.

### BACKGROUND OF THE INVENTION

1. Field of the Invention

The present invention relates generally to data processing systems and the Internet, and more particularly to object oriented technology systems for building business websites.

2. Prior Art

Computer programs have typically been developed using procedural programming techniques. Procedural programming techniques emphasize structuring the data processing procedures to which data values are subjected. Efforts to reduce long software development times and high software maintenance costs have resulted in structured programming techniques that attempt to reuse blocks of programming code. For example, tasks or processes that must be repeated can be written as system programming routines or program library functions. Program developers then provide an application program to accomplish a desired result using calls to the system routines and library functions.

System routines and library functions provide only a limited reduction in software development time and maintenance costs. Once a procedural application program is written, it is relatively difficult to incorporate new features or additional data types. There are many processes in an application program that cannot be easily extracted from program code and reused. Additionally, data types often cannot be inserted into a procedural program without extensive rewriting of the original program code. Thus, even if new features in a program can be implemented using processes similar to those already in the application, the programming for such processes must be largely duplicated, with slight modifications, to provide the new features. This increases program development time. Moreover, if such programs must operate with other applications, it can be difficult to ensure that the changes will interface properly.

Object oriented programming (OOP) techniques encapsulate data and the methods that operate on data. This permits program development to more closely model real-world systems for problem solving, and breaks up program development efforts into smaller, more manageable pieces. OOP programs are developed around object classes that have attributes and methods. Although OOP techniques have done much to improve program development efficiency, such techniques still require a great degree of code generation on the part of application developers and limit program reuse among different classes.

OOP frameworks have been developed in an effort to further reduce program development costs. A framework is a set of OOP classes that embodies a predetermined set of attributes and methods for providing a common group of functions. An application program developer utilizes the framework and builds upon it, adding subclasses and attributes and modifying methods according to the problem to be solved.

In particular, in some fields such as building business websites, the system model is relatively uniform, and designs of OOP classes differ only in minutiae. According to OOP technique, if a class is modified, an application program containing the modified class must be compiled again. This limitation is manifest in, among other things, systems for building business websites, in which application programs have to be repeatedly compiled due to only partial modification of classes. Conventional systems for building business websites do not provide a website development framework that enables an application program developer to build a business website rapidly. In particular, such systems do not provide an extensible OOP technique that allows an application program developer to partly modify attributes of classes without the need for re-compiling the application program.

### SUMMARY OF THE INVENTION

It is a general object of the present invention to provide an object oriented technology system for building business websites, whereby said system provides a website development framework for building business websites.

It is another object of the present invention to provide an object oriented technology system for building business websites, whereby said system provides an extensible OOP technique that implements partial modification of attributes of classes without re-compiling of an associated application program.

In order to achieve the aforementioned objects, the present invention provides an object oriented technology system for building business websites, the system comprising a web server, a database server, and a database. The web server runs a website development framework, for building business websites on the web server. The website development framework comprises a plurality of predefined classes for creating business logics suitable for business websites to be built. The predefined classes can be divided into a plurality of domains. In a preferred embodiment of the present invention, the domains comprise a catalog domain, a shopping cart domain, an inventory domain, a price domain, a purchase domain, a payment processor domain, a freight domain, a freight calculator domain, a membership domain, and an e-mail domain. The website development framework uses an extensible OOP technique which divides the attributes of each predefined class into basis attributes that are defined in the corresponding class, and alterable attributes that are defined in a configuration file. The database server and the database cooperatively provide storage and access services for data required by the website development framework and business websites to be built.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of architecture of an object oriented technology system for building business websites, in accordance with a preferred embodiment of the present invention;

FIG. 2 is a schematic diagram of architecture of a website development framework provided by a web server of the system of FIG. 1;

FIG. 3 is a schematic diagram of an extensible OOP technique implemented in the website development framework of FIG. 1;

FIG. 4 is a schematic diagram of a plurality of core classes defined in the website development framework of FIG. 1; and

FIG. 5 is a flow chart of a preferred method for developing a business website based on the website development framework of FIG. 1.

### DETAILED DESCRIPTION OF PREFERRED EMBODIMENT OF THE INVENTION

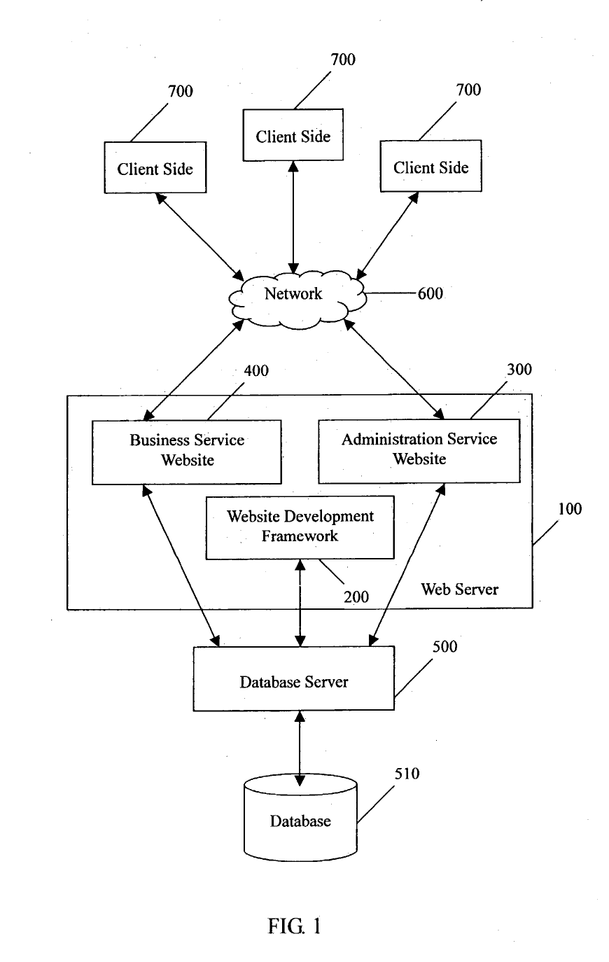

FIG. 1 is a schematic diagram of architecture of an object oriented technology system for building business websites, in accordance with a preferred embodiment of the present invention. The object oriented technology system comprises a web server 100, a database server 500, a database 510, a network 600, and a plurality of client sides 700.

The web server 100 is any appropriate type of computer equipped with server software known in the art. Said server software may be Microsoft Internet Information Server that supports Active Server Pages (ASP). The web server 100 runs a website development framework 200, an administration service website 300, and a business service website 400.

It is to be understood that the object oriented technology system is capable of building any number of business websites. However, for the sake of illustrating the present invention as simply as possible, only one business service website 400 is described hereinafter.

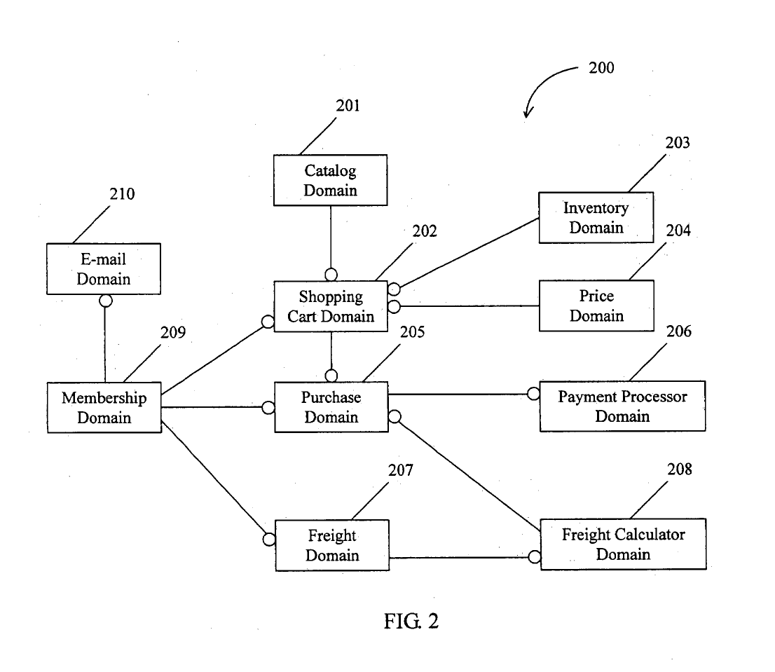

The website development framework 200 comprises a plurality of predefined classes and a system configuration kit. The system configuration kit is a set of visual development tools for managing the predefined classes and configuring the administration service website 300 and the business service website 400. The predefined classes are a plurality of universal classes for building business websites. This is described in more detail below with reference to FIG. 2. On the basis of the website development framework 200, an application program developer creates business logics suitable for building the administration service website 300 and the business service website 400. On the basis of the business logics, an application program developer designs ASP files to build the administration service website 300 and the business service website 400.

The database server 500 and the database 510 cooperatively provide storage and access services for data required by the website development framework 200, the administration service website 300 and the business service website 400.

The network 600 is the Internet, or a wide area network that comprises a plurality of local area networks connected via routers and switches.

The client side 700 is any appropriate type of computer that runs a web browser. A website administrator uses the web browser to log on the administration service website 300 in order to manage the business service website 400. The business service website 400 may be concerned with any of an endless variety of business matters, such as introducing products, providing information for customers, or providing online trade facilities. For the purposes of illustrating the preferred embodiment of the present invention, it will be assumed that the business service website 400 provides online trades. A common user uses the web browser to log on the business service website 400 in order to perform online trades.

FIG. 2 is a schematic diagram of architecture of a website development framework 200 provided by the web server 100 of the object oriented technology system of FIG. 1. In the preferred embodiment of the present invention, the predefined classes provided in the website development framework 200 can be divided into a plurality of domains: catalog domain 201, shopping cart domain 202, inventory domain 203, price domain 204, purchase domain 205, payment processor domain 206, freight domain 207, freight calculator domain 208, membership domain 209, and e-mail domain 210. Each domain is a set of correlative predefined classes, and is used to accomplish a series of tasks or functions. The definition and integration of domains represent the main capabilities of the website development framework 200.

The catalog domain 201 records all descriptive information on products for sale in the business service website 400. The descriptive information may include descriptions, images, weights, special bundles, sales methods, and customer reviews. The catalog domain 201 is configured to be flexible to allow for virtually any type of durable good.

The shopping cart domain 202 provides a vehicle for customers to hold items while customers are carrying out online trades. The shopping cart domain 202 is configured to be printable in order to provide lists of products selected by customers. The shopping cart domain 202 is associated with the catalog domain 201, the inventory domain 203, the price domain 204, and the membership domain 209.

The inventory domain 203 is configured to record available quantities and lead times for each item in the catalog domain 201. The inventory domain 203 can be replaced by a third party inventory management system if necessary.

The price domain 204 handles price information on items in the catalog domain 201 including prices, price lists, and discounts. The price domain 204 is configured to be flexible to allow multiple prices and price lists to be associated with an item.

The purchase domain 205 handles information on online trades provided by customers. The information on online trades includes item lines, quantities and shipping charges. The purchase domain 205 is associated with the shopping cart domain 202, the freight calculator domain 208 and the membership domain 209. Moreover, the purchase domain 205 is configured to handle information on product returns. The purchase domain 205 tracks returned items, and provides customers with a web-based mechanism to view and confirm that a product has been successfully returned.

The payment processor domain 206 is configured to support multiple forms of payment, and can interface to any payment processor program.

The freight domain 207 provides lists of shipment carriers and shipping methods for items in the catalog domain 201. Each shipment carrier is associated with a respective freight calculator to determine the charges for shipping an order to a customer.

The freight calculator domain 208 calculates shipping charges based on total weight and/or amount of total order. Shipping zones are defined by country and region. Shipping methods are associated with shipping zones. Shipment carriers are associated with shipping methods.

The membership domain 209 records information on membership registration and customer contact. The membership domain 209 contains membership registration and allows users to track customer contact information such as postal addresses, phone numbers and e-mail addresses. The membership domain 209 also allows an external program to track orders from referring sites, offer commissions to the referred, capture and display purchase histories by member, track tax exempt statuses, and set credit limits.

The e-mail domain 210 is configured to set up automated e-mail notifications, such as confirmations of orders, confirmations of shipment, welcome e-mails, and so on. The e-mail domain 210 uses templates for creating and sending different e-mail messages.

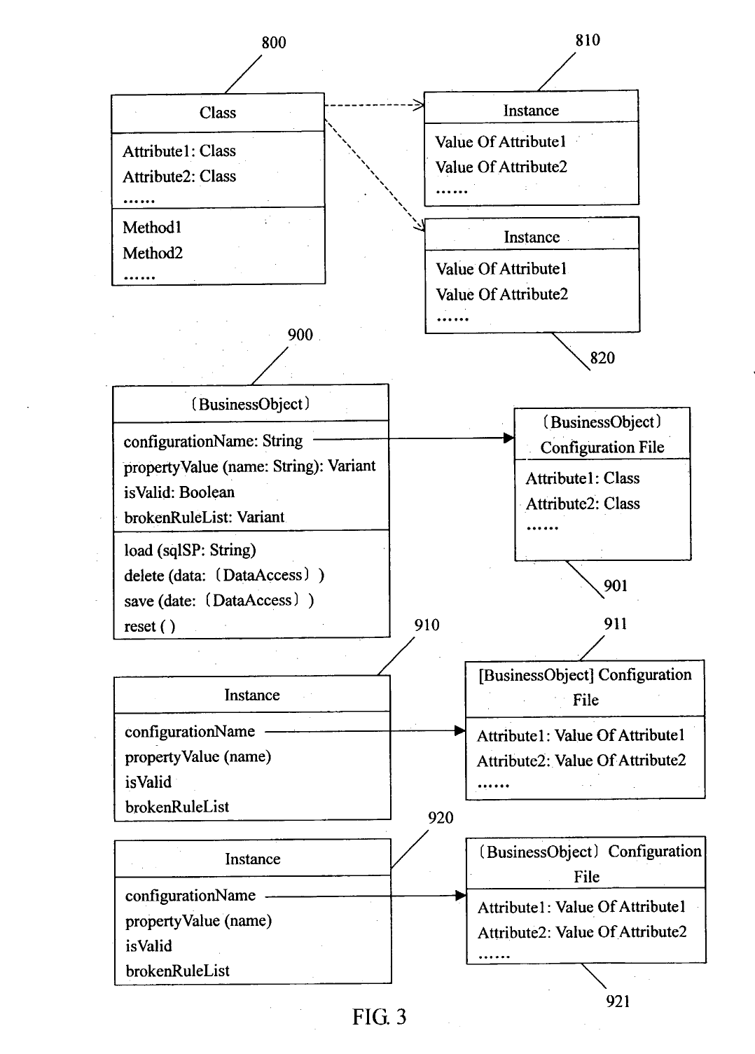

FIG. 3 is a schematic diagram of an extensible OOP technique implemented in the website development framework 200 of the web server 100 of the object oriented technology system.

OOP technique is a kind of programming technique that divides the configuration of an application program into the configuration of a plurality of objects. The objects are the components of an application program. The objects are not only standalone, but also cooperate with each other. A class is an abstract definition of an object in an application program, the class comprising a plurality of attributes and methods. An instance is a concrete definition of an object in an application program, the instance implementing the structure of a class.

OOP needs to employ a programming language that supports OOP techniques, such as Small Talk, C++ or Visual Basic. In the preferred embodiment of the present invention, the employed programming language is Visual Basic (VB). VB assembles a plurality of classes, and allows an application program developer to self-define classes. In the preferred embodiment of the present invention, each assembled class in VB is titled with an English word that begins with a capital letter, for example String. And each self-defined class is titled with a [class name], for example [BusinessObject].

Class 800 is an abstract definition of an object in an application program. Class 800 defines a plurality of attributers such as Attributer 1, 2 and so on. The classes of the attributers may be the assembled classes in VB or the self-defined classes. Class 800 also defines a plurality of methods such as Method 1, 2 and so on. The methods are the operations of dealing with the attributers. In the application program, a plurality of instances 810, 820 can be constructed according to class 800. The instances 810, 820 comprise their respective attributes defined in class 800, and shares the methods defined in class 800. The values of the instances' 810, 820 respective attributes may or may not be the same.

However, the attributes and methods of class 800 are never modified after the application program containing class 800 is compiled. In order to implement an extensible OOP technique, the present invention divides the attributes of a class into two parts: the basis attributes and the alterable attributes. Some of the basis attributes are configured to read the alterable attributes or access the values of the alterable attributes.

[BusinessObject] 900 is one of core classes in the website development framework 200. The basis attributes of [BusinessObject] 900 are defined in the [BusinessObject] 900, and the alterable attributes of [BusinessObject] 900 are defined in a [BusinessObject] configuration file 901. The basis attributes of [BusinessObject] 900 comprise an attribute of configurationName whose class is String, an attribute of propertyValue whose class is Variant, an attribute of isValid whose class is Boolean, and an attribute of brokenRuleList whose class is Variant.

The attribute of configurationName is a read/write property that specifies the name of the [BusinessObject] configuration file 901 in order to read the alterable attributes of [BusinessObject] 900. In an application program, the instances of [BusinessObject] 900 can have their respective attributes of configurationName in order to have different alterable attributes.

The attribute of propertyValue is a read/write property for accessing all of the alterable attributes of an instance of [BusinessObject] 900. A specific alterable attribute is accessed through the attribute of propertyValue by providing the name of the specific alterable attribute as a parameter, for example propertyValue (name), wherein the parameter of name refers to the name of the specific alterable attribute. The specific alterable attribute may be read-only, read/write, or write-once access.

The attribute of isValid is a read-only property for determining the validity of the alterable attributes of an instance of [BusinessObject] 900. The attribute of isValid returns true if an instance of [BusinessObject] 900 passes all validation examinations. Otherwise, the attribute of isValid returns false.

The attribute of brokenRuleList is a read-only property that returns an array of validation rules that represent the validation errors for an instance of [BusinessObject] 900.

In order to implement the extensible OOP technique, [BusinessObject] 900 also defines a plurality of methods that are used to initialize, save, delete, and reset an instance of [BusinessObject] 900.

In this regard, the method of load (sqlSP: String) is used to initialize an instance of [BusinessObject] 900, the parameter of sqlSP referring to the name of a stored procedure. The stored procedure is used to specify the alterable attributes for an instance of [BusinessObject] 900. In an application program, the method of load (sqlSP: String) can initialize different instances of [BusinessObject] 900 that have different alterable attributes via different parameters of sqlSP. The alterable attributes of an instance of [BusinessObject] 900 may be the same as the attributes defined in the [BusinessObject] configuration file 901, or a subset of the attributes defined in the [BusinessObject] configuration file 901.

The method of save ( ) is used to save the information on an instance of [BusinessObject] 900. The saved information comprises the values of basis attributes, the values of alterable attributes and the relevant information on the instance of [BusinessObject] 900. If the instance of [BusinessObject] 900 is not firstly saved but the value of at least one attribute is modified, the method of save ( ) will save the information on the instance of [BusinessObject] 900 again.

The method of delete ( ) is used to delete a piece of saved information on an instance of [BusinessObject] 900. The method of delete ( ) provides the reverse function of the method of save ( ).

The method of reset ( ) is used to reset an instance of [BusinessObject] 900. The instance of [BusinessObject] 900 can be reset to the state of initial creation. The method of reset ( ) allows the instance of [BusinessObject] 900 to be reused to hold a new instance of [BusinessObject] 900 without actually creating a new instance of [BusinessObject] 900.

Instances 910, 920 are a plurality of instances of [BusinessObject] 900. According to OOP technique, the instances 910, 920 have their respective values of basis attributes, said basis attributes being the same with the basis attributes of [BusinessObject] 900. According to the extensible OOP technique provided by the present invention, the instances 910, 920 own their respective [BusinessObject] configuration files 911, 921 in order to have different alterable attributes. The [BusinessObject] configuration files 911, 921 are created by the method of load (sqlSP: String) called by the relevant instances 910, 920. Using the different value of the parameter of sqlSP, the method of load (sqlSP: String) provides the instances 910, 920 with the alterable attributes determined dynamically.

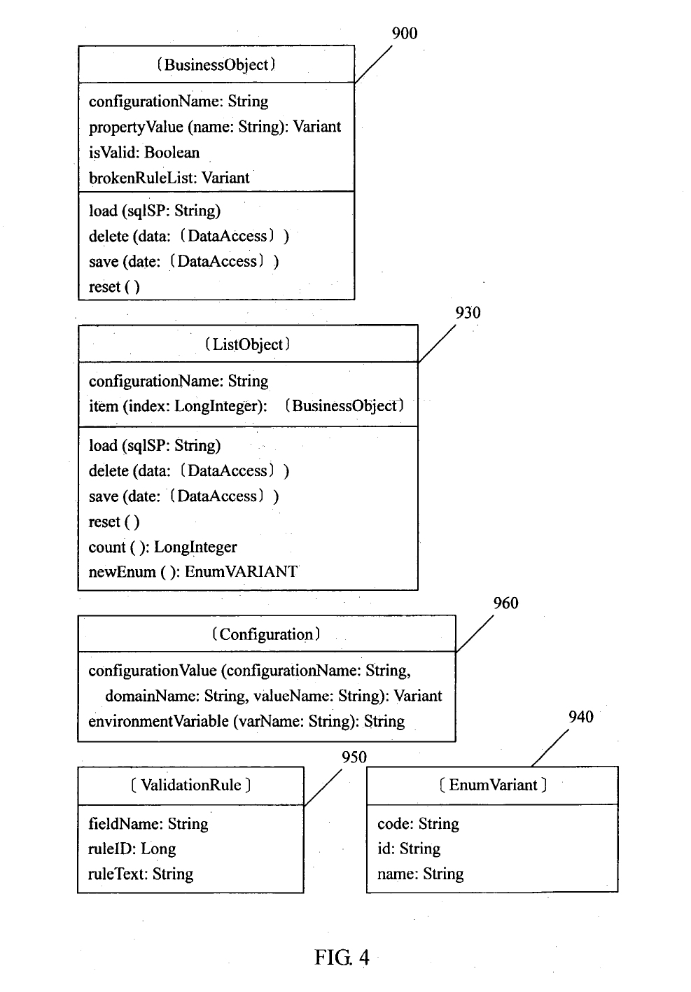

FIG. 4 is a schematic diagram of a plurality of core classes defined in the website development framework 200. In the preferred embodiment of the present invention, the website development framework 200 defines a plurality of core classes of [BusinessObject] 900, [ListObject] 930, [EnumVariant] 940, [ValidationRule] 950, and [Configuration] 960. So-called “core classes” are the construct foundation that implements the website development framework 200. Technicians skilled in the art of OOP are aware that more and more complicated classes can be extended from the core classes to implement the website development framework 200.

[BusinessObject] 900 is the core class for creating a unit object. [BusinessObject] 900 is described above with reference to FIG. 3.

[ListObject] 930 is the core class for creating an aggregate object that comprises two basis attributes: configurationName, and item (index: Integer).

The attribute of configurationName is a read/write property that specifies the name of the configuration file (not shown) of [ListObject] 930 in order to read the alterable attributes of [ListObject] 930. In an application program, the instances of [ListObject] 930 can have their respective attributes of configurationName in order to have different alterable attributes.

The attribute of item (index: Integer) is a read/write property for accessing the relevant alterable attributes of [ListObject] 930 via the parameter of index. The class of the attribute of item (index: Integer) is [BusinessObject] 900 because [BusinessObject] 900 is the core class for creating a unit object in the preferred embodiment of the present invention.

[ListObject] 930 defines a plurality of methods. The methods of load (sqlSP: String), save ( ), delete ( ), and reset ( ) are used to initialize, save, delete, and reset an instance of [ListObject] 930.

The method of count ( ) is used to return the quantity of unit objects contained in an instance of [ListObject] 930.

The method of newEnum ( ) is used to return an instance of [EnumVariant] 940 that enumerates a unit object contained in an instance of [ListObject] 930.

[EnumVariant] 940 is the core class for identifying a unit object that comprises three basis attributes: id, code, and name. [EnumVariant] 940 comprises no alterable attributes. The attribute of id is the identification number corresponding to a unit object. The attribute of code is the code corresponding to a unit object. The attribute of name is the name corresponding to a unit object. In the preferred embodiment of the present invention, the only way to create an instance of [EnumVariant] 940 is the method of newEnum ( ) in [ListObject] 930 and its extended classes in order to ensure unique identifications of the unit objects contained in an instance of [ListObject] 930 and its extended classes.

[ValidationRule] 950 is the core class for representing invalidation of the alterable attributes in an instance that comprises three basis attributes: propertyName, ruleID, and ruleText. [ValidationRule] 950 comprises no alterable attributes. According to the extensible OOP technique provided by the present invention, the alterable attributes of an instance can be determined dynamically. In order to ensure the validation of the alterable attributes of an instance, the validation examination is performed when the alterable attributes of an instance are changed.

[Configuration] 960 is the core class for accessing the general settings of a domain that comprises two basis attributes: configurationValue (configurationName: String, domainName: String, valueName: String), and environmentVariable (varName: String). [Configuration] 960 comprises no alterable attributes.

In this regard, the attribute of configurationValue (configurationName: String, domainName: String, valueName: String) is a read/write property for returning the value associated with the parameter of valueName under the domain specified by domainName in the configuration file specified by the configurationName.

The attribute of environmentVariable (varName: String) is a read-only property for returning the value of a windows environment variable associated with the parameter of varName.

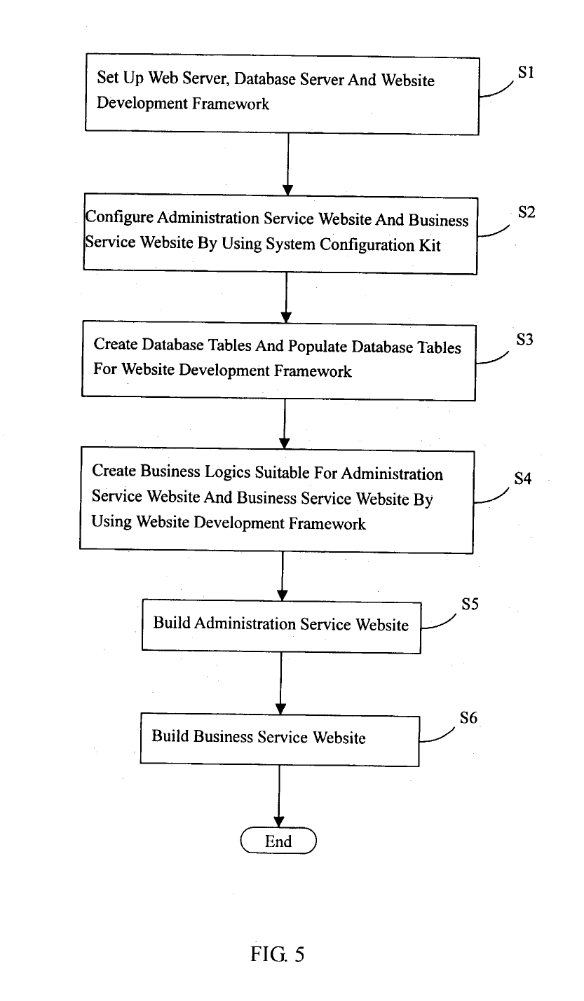

FIG. 5 is a flow chart of a preferred method for developing a business website based on the website development framework 200.

Firstly, an application program developer sets up the web server 100 and the database server 500, and installs the website development framework 200 in the web sever 100 (Step SI). The application program developer uses the system configuration kit provided by the website development framework 200 to configure any number of business websites to be built. In the preferred embodiment of the present invention, both the administration service website 300 and the business service website 400 are to be built in the web server 100. Therefore the application program developer needs to configure two different ports, one for the administration service website 300 and one for the business service website 400 (Step S2). The application program developer logs on the database server 500, and creates a plurality of database tables in the database 510. The application program developer then uses the system configuration kit to populate the database tables for the website development framework 200 (Step S3). The application program developer uses the website development framework 200 as a base to create business logics suitable for the administration service website 300 and the business service website 400. That is, the application program developer modifies the alterable attributes of the predefined classes and extends new classes from the predefined classes in order to implement capabilities not provided by the website development framework 200 (Step S4). Based on the business logics, the application program developer designs a plurality of active server pages to build the administration service website 300 (Step S5). Based on the business logics, the application program developer designs a plurality of active server pages and dynamic pages to build the business service website 400 (Step S6).

While the present invention has been described above, it should be understood that it has been presented by way of example only and is not to be limited to the above-described exemplary embodiment and method. Instead, the present invention should be defined only in accordance with the following claims and their equivalents.

What is claimed is:

1. An object oriented technology system for building business websites, the system comprising a web server, a database server, and a database, wherein:
the web server runs a website development framework for building business websites on the web server, the website development framework comprising a plurality of predefined classes for creating business logics suitable for business websites to be built; and
the database server and the database cooperatively provide storage and access services for data required by the website development framework and websites to be built.

2. The system of claim 1, wherein at least one of the predefined classes comprises basis attributes that are defined in the corresponding class and alterable attributes defined in a configuration file.

3. The system of claim 2, wherein at least one of the basis attributes is defined to specify the configuration file.

4. The system of claim 2, wherein at least one of the basis attributes is defined to read the alterable attributes.

5. The system of claim 2, wherein there is at least one method defined in the predefined class for creating a configuration file for an instant of the predefined class.

6. The system of claim 5, wherein the configuration file of the predefined class and the configuration file of the instant of the predefined class are both stored in the database.

7. The system of claim 1, wherein the predefined classes comprise a catalog domain, the catalog domain comprising a plurality of classes that record descriptive information on products for sale in the websites.

8. The system of claim 1, wherein the predefined classes comprise a shopping cart domain, the shopping cart domain comprising a plurality of classes that record information on items selected through online trades.

9. The system of claim 1, wherein the predefined classes comprise an inventory domain, the inventory domain comprising a plurality of classes that record information on stock in trade.

10. The system of claim 1, wherein the predefined classes comprise a price domain, the price domain comprising a plurality of classes that record information on prices of goods being sold.

11. The system of claim 1, wherein the predefined classes comprise a purchase domain, the purchase domain comprising a plurality of classes that balance online trades provided by customers.

12. The system of claim 1, wherein the predefined classes comprise a payment processor domain, the payment processor domain comprising a plurality of classes that provide a plurality of payment methods.

13. The system of claim 1, wherein the predefined classes comprise a freight domain, the freight domain comprising a plurality of classes that handle shipment carriers and methods of shipping goods.

14. The system of claim 1, wherein the predefined classes comprise a freight calculator domain, the freight calculator domain comprising a plurality of classes that calculate shipping charges based on total weight or amount of total order.

15. The system of claim 1, wherein the predefined classes comprise a membership domain, the membership domain comprising a plurality of classes that record information on membership registration and customer contact.

16. The system of claim 1, wherein the predefined classes comprise an e-mail domain, the e-mail domain comprising a plurality of classes for setting up automated e-mail notification.

17. A method of making business service websites, comprising steps of:
setting up a web server, a database server and a website development framework;
configuring an administration service website and at least one a business service website by using a system configuration kit;
creating database tables and populating said database tables for said website development framework;
creating business logics suitable for said administration service website and said business service website by using said website development framework;
building said administration service website; and
building said business service website.
